(19) United States
(12) Patent Application Publication
(10) Pub. No.: US 2026/0086057 A1
(43) Pub. Date: Mar. 26, 2026

(54) THERMOGRAPHIC COMPONENT TEST

(71) Applicant: VOIDSY GMBH, Wels (AT)

(72) Inventors: Gernot MAYR, Altmünster (AT); Günther MAYR, Altenberg (AT); Holger PLASSER, Ried in der Riedmark (AT); Gregor THUMMERER, Waidhofen an der Ybbs (AT)

(21) Appl. No.: 19/109,461

(22) PCT Filed: Sep. 6, 2023
(86) PCT No.: PCT/AT2023/060312

§ 371 Date: Mar. 6, 2025

(30) Foreign Application Priority Data
Sep. 7, 2022 (AT) A50679/2022

(51) Int. Cl. G01N 25/72; G06T 7/00; G06T 7/73

(52) U.S. Cl. CPC G01N 25/72; G06T 7/0002; G06T 7/73; G06T 2207/10048

(57) ABSTRACT

The disclosure relates to a device and a method for thermographic component test with an excitation source for generating an unsteady heat flow in a test object, with an infrared detector array for detecting heat radiation emitted from a surface of the test object, a surface scanner, a control device and an evaluation device, wherein the device comprises an inertial measuring unit for detecting movements of the device.

### CROSS-REFERENCE TO RELATED APPLICATIONS

This application is a national US phase of PCT/AT2023/060312 filed 6 Sep. 2023, which claims priority to Austrian patent application A50679/2022, filed 7 Sep. 2022, the disclosure of each of which is hereby incorporated herein by reference.

### TECHNICAL FIELD

The disclosure relates to a device and a method for a non-destructive component test.

### TECHNOLOGICAL BACKGROUND

Active thermography is known from the prior art as a non-destructive and imaging test method for material and component characterization. This is based on the thermal excitation of the test body by means of absorption of optical radiation, induction of eddy currents, coupling in of mechanical waves or other forms of energy which lead to a time-dependent temperature change in the test body. The heat radiation of the test body can be detected contactlessly by infrared sensors—designed as a point, line or area detector. The temporally variable heat diffusion process is analyzed on the basis of the measured temperature field at the component surface and component features can be detected and identified therefrom. Known technical implementations of active thermography are, for example, laboratory structures on fixed stands or also mobile, hand-guided or robot-guided test systems.

### SUMMARY OF THE DISCLOSURE

There may be a need to provide a device and a method for non-destructive component test with which deep-lying component features or defects can be assigned to the three-dimensional component geometry with a higher reliability. Furthermore, there may be a need to provide a device by which non-destructive component tests can be used in a larger field of applications and are applicable with improved user-friendliness.

These needs are met by a device and a method according to the claims.

The device according to the disclosure for a thermographic component test comprises an excitation source for generating an unsteady heat flow in a test object, an infrared detector array for detecting heat radiation emitted from a surface of the test object, a surface scanner, a control device and an evaluation device, wherein the device comprises an inertial measuring unit for detecting movements of the device. In addition, the device comprises a physical unit for user authentication.

In particular, the development of the device according to which the evaluation device comprises a geometry detection system for calculating spatial coordinates of the surface of the test object is advantageous.

According to an advantageous embodiment of the device, it is provided that the geometry detection system is configured to calculate a relative spatial position between the device and the test object.

A development of the device provides that the infrared detector array of the surface scanner and the inertial measuring unit are arranged relative to one another at defined distances and defined orientations in the device. This has the advantage that a flexible and user-friendly applicability of the device can thereby be achieved.

The embodiment of the device according to which the evaluation device is configured for program-controlled reconstruction of defects in a test object or of material differences or material properties of a test object is also advantageous, wherein a time- and location-dependent surface temperature signal Tₘₑₛₛ is calculated by the evaluation device from data of infrared images of the infrared detector array, and wherein the surface temperature signal Tₘₑₛₛ is transformed into a mirror source representation T_{Sq} using a regularization method. This has the advantage that reconstructed component features can thereby be assigned to the true component features (defects, boundary surfaces, etc.) with a higher reliability.

The object of the disclosure is also achieved autonomously by a method for a thermographic component test of a test object with a device comprising an excitation source, an infrared detector array, a surface scanner, a physical unit for user authentication, a control device and an evaluation device, comprising the following method steps: authenticating a user, detecting a spatial position and orientation of the device relative to the test object and detecting a surface of the test object with the surface scanner; generating an unsteady heat flow in the test object by the excitation source; recording infrared images of the surface of the test object with the infrared detector array during a preselected measuring period; reconstructing a spatial position of a defect from detected data of the infrared images by the evaluation device, wherein a surface temperature signal Tₘₑₛₛ is calculated by the evaluation device from the data of the infrared images for reconstructing the defect, and wherein the surface temperature signal Tₘₑₛₛ is transformed into a mirror source representation T_{Sq} using a regularization method.

It also proves to be advantageous if a Green's function based on the heat conduction equation is used in the method in the regularization method.

The procedure according to which additional information from a group comprising a dimensionality of the heat flow, a number of boundary layers in the test object, a position of boundary layers in the test object, thermophysical material properties or boundary conditions is used in reconstructing the spatial position of the defect is advantageous.

According to an advantageous development of the method, it is provided that a component identification is carried out by the device. A priori information of the test object is thereby made available as additional information.

According to an advantageous development of the method, it is provided that a user authentication is carried out by the device. The additional information is thereby made dependent on the device user.

Technologies such as a contactless transceiver system (radio-frequency identification technologies), optoelectronically detectable writings, bar codes or multidimensional codes (by means of a camera or scanner), biometric authentication, inter alia, by face, fingerprint, eye iris or voice recognition, manual authentication by means of a user interface or a card reader, or digital authentication based on cryptographic handshaking methods can be used for component identification and also for user authentication.

According to an advantageous development of the method, it is provided that an inertial measuring unit is arranged in the device, wherein the infrared detector array of the surface scanner and the inertial measuring unit are arranged relative to one another at defined distances and defined orientations in the device.

The procedure according to which the spatial position and orientation of the device relative to the test object is measured by the inertial measuring unit is also advantageous. This makes it possible for the image sequence to be corrected and stabilized by the inertial measuring unit.

According to an alternative procedure, it is provided that external data sources are taken into account for detecting the spatial position and orientation of the device and for detecting the surface of the test object.

An advantageous embodiment of the method provides that additional information about the component geometry and the material properties of the test object is used for optimized discretization of the reconstruction space.

The advantage of an even larger accuracy and reliability of the assignment of defects or component features to the three-dimensional geometry of the test object is achieved by the procedure according to which the method steps are repeated one or more times, carried out from a different spatial position and orientation of the device relative to the test object, and results of reconstructions of the spatial position of the defect are superpositioned.

The development of the method according to which temperature- and location-calibrated image data are calculated from the infrared images also proves to be advantageous.

According to a likewise advantageous procedure, it is provided that the extracted features of the defects can be used for data compression.

For a better understanding of the disclosure, this is explained in more detail with reference to the following figures.

### BRIEF DESCRIPTION OF THE DRAWINGS

In each case, in a highly simplified, schematic illustration:

FIG. 1 shows a device for a non-destructive component test of a test object;

FIG. 2 shows a view of the device, according to FIG. 1, corresponding to a viewing direction onto its sensors or onto its infrared detector array;

FIG. 3 shows a flow chart of the method for the thermographic component test;

FIG. 4 shows details of the regularization method according to method step “regularization and reconstruction” in FIG. 3;

FIG. 5 shows the device when carrying out the thermographic test of the test object;

FIG. 6 shows an illustration of evaluation steps, carried out with the regularization method, of the measured surface temperature signals with reference to temporal and spatial temperature profiles;

FIG. 7 shows evaluation steps of the regularization method of a further application, illustrated by temporal and spatial temperature profiles;

FIG. 8 shows a further exemplary embodiment of a device for non-destructive component test.

### DETAILED DESCRIPTION OF THE DRAWINGS

As an introduction, it should be noted that, in the differently described embodiments, identical parts are provided with identical reference signs or identical component designations, wherein the disclosures contained in the entire description can be transferred analogously to identical parts with identical reference signs or identical component designations. The position specifications selected in the description, such as, for example, top, bottom, side, etc., are also related to the figure directly described and illustrated, and these position specifications are to be transferred analogously to the new position in the event of a change in position.

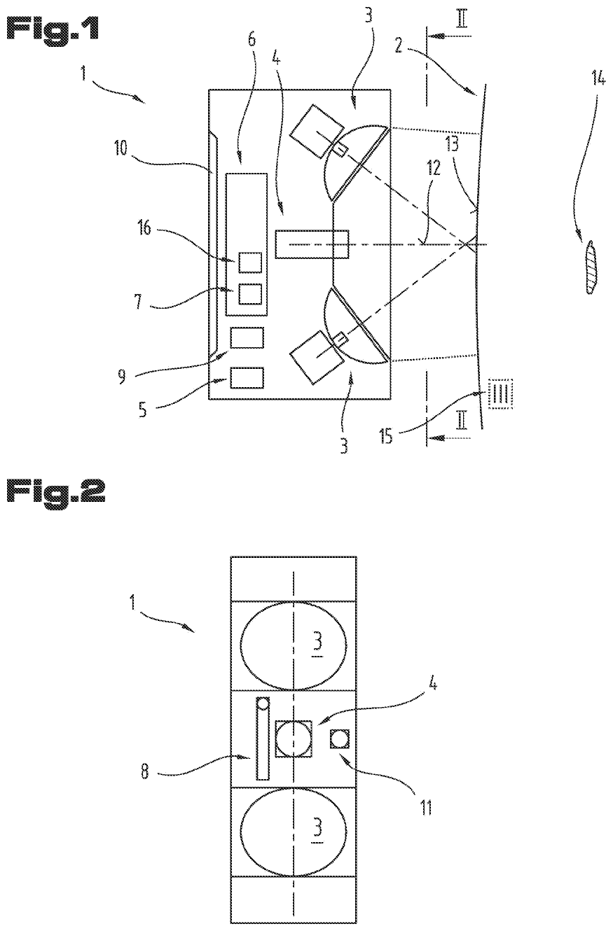

FIG. 1 shows a device 1 for a non-destructive component test of a component or test object 2. The device 1 is suitable for carrying out a method for a component test using active thermography and, for this purpose, comprises an excitation source 3 and an infrared detector array 4. In addition to an electrical supply unit 5, a control device 6 or a processor unit is furthermore provided for controlling the test sequence and controlling or regulating the components of the device 1 required for this purpose. A part of the control device 6 is formed by an evaluation device 7 for program-controlled processing of the measurement signals detected by the infrared detector array 4 or by further sensors. The device 1 furthermore comprises a surface scanner 8 for detecting the geometry data or the geometry features of the test object 2. Finally, the device 1 is also configured with an inertial measuring unit 9 for a motion detection of the device 1. The device 1 furthermore also comprises an operating terminal 10, which furthermore comprises at least one digital, bidirectional communication interface for providing data or for retrieving additional information from external data sources. The device 1 can optionally also be equipped with an optical camera or with an optical imaging system 11 (a so-called RGB camera) for the visible wavelength range.

FIG. 2 shows a view of the device 1 according to FIG. 1, corresponding to a viewing direction onto the infrared detector array 4 or a viewing direction corresponding to an optical axis 12 of the infrared detector array 4.

As illustrated in FIG. 1, the test object 2 comprises below a surface 13 in its interior an inhomogeneity—in the following referred to as defect 14 in a simplified manner.

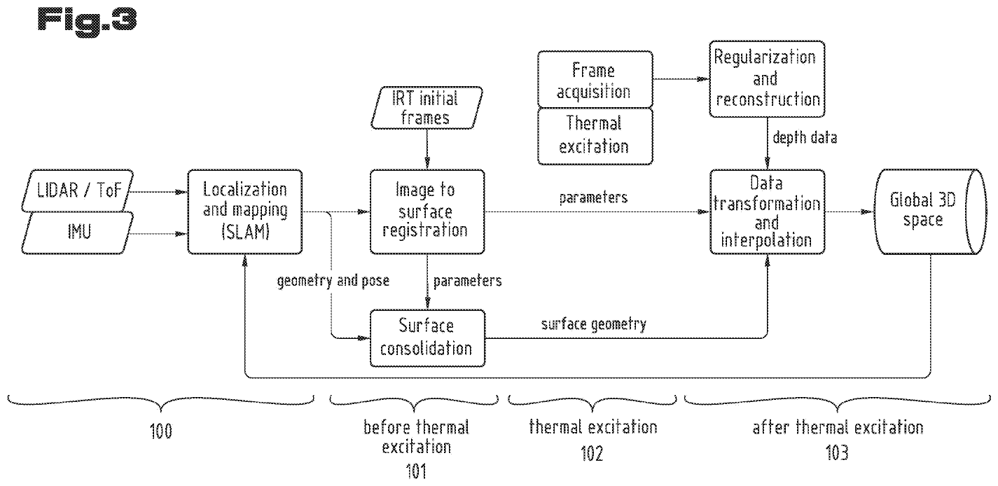

FIG. 3 shows, with reference to a flow chart, the sequence of the method for the thermographic component test on the test object 2 (FIG. 1). This is a multistage signal processing procedure. In the course of an initial measurement, the surface 13 of the test object 2 is first optically detected and the initial pose (position and orientation) of the device 1 relative to the test object 2 or its surface 13 is determined. Before the thermal excitation of the test object 2 with the excitation source 3, one or more static (passive) infrared images of the test object 2 are detected with the infrared detector array 4.

By determining transformation parameters, in each case one image point I(u,v) can be assigned to one or more coordinate points p (FIG. 5). Since no movement of the device 1 takes place between the position determination of the device 1, the thermal excitation by means of the excitation source 3 and the recording of the thermal response by the infrared detector array 4, this assignment also applies to the temporally dynamic part of the infrared radiation emitted by the test object 2 and therefore does not necessarily have to be carried out during the measurement of the thermal excitation and response. The coordinate transformation can be determined by a previously carried out calibration of the infrared detector array 4 and of the surface scanner 8 or by image registration methods on the basis of characteristic image features, such as edges or differences in the emissivity.

In order to reduce artifacts in the reconstruction and registration step, a consolidation of the scanner data takes place (if appropriate removal of outliers, noise filtering, reduction of image size, reduction of the local resolution). Furthermore, in each case one normal vector nₚ is determined for all relevant coordinate points of the surface 13 of the test object 2. The normal vectors nₚ are always oriented in the direction of the component interior (FIG. 5).

After the thermal excitation with the excitation source 3, the thermal response of the test object 2 is detected for a sufficiently long time by recording infrared images with the infrared detector array 4. The measuring period and excitation form determine the desired penetration depth into the test object 2. The image repetition rate during the recording of the infrared images by the infrared detector array 4 determines the resolution capability in the axial direction of the device 1, that is to say in the depth direction of the test object 2.

With the aid of the evaluation device 7, the thermal response for each image point is inversely transformed into a mirror source representation by means of a so-called regularization. In this illustration, structures lying below the surface, such as the defect 14, are illustrated as pulse-shaped features in a discrete, equidistant signal I(u,v,w).

FIG. 3 gives an overview of the measures to be carried out in the thermographic test methods and also the temporal sequence thereof. After the device 1 has been put into operation, the spatial position and also the orientation of the device 1 are determined with the aid of the inertial measuring unit (IMU). On the other hand, the outer geometry of the test object 2 is measured with the aid of the surface scanner 8. The measurement data obtained supply, as measure 100, information about the geometry and also the spatial relative arrangement of the device 1 and the test object 2. The measurements according to measure 100 are preferably carried out permanently, that is to say continuously over the entire temporal profile of the component test of the test object 2. This is advantageous in particular for the case in which the device 1 is configured as a hand-held device. Portion 101 comprises measurements or detections taking place before the thermal excitation of the test object 2. Thus, one or more static (passive) infrared images of the test object 1 are recorded by the thermal excitation with the infrared detector array 4 and transformation parameters for assigning coordinate points p to respective image points I(u,v) of the infrared images are determined. In a subsequent portion 102, the thermal excitation with the aid of the excitation source 3 and at the same time a detection of the thermal response by recording a sequence of infrared images by the infrared detector array 4 take place. The images of the infrared detector array 4 recorded represent surface temperature data Tₘₑₛₛ(p) of points p of the surface 13 of the test object 2 and also the temporal profile of the surface temperatures. The surface temperature signals obtained in this way are subjected in a final portion 103 to an evaluation procedure using the evaluation device 7. For this purpose, the surface temperature signals Tₘₑₛₛ are subjected to a so-called regularization method. This makes it possible to reconstruct the defect 14 in the test object 2.

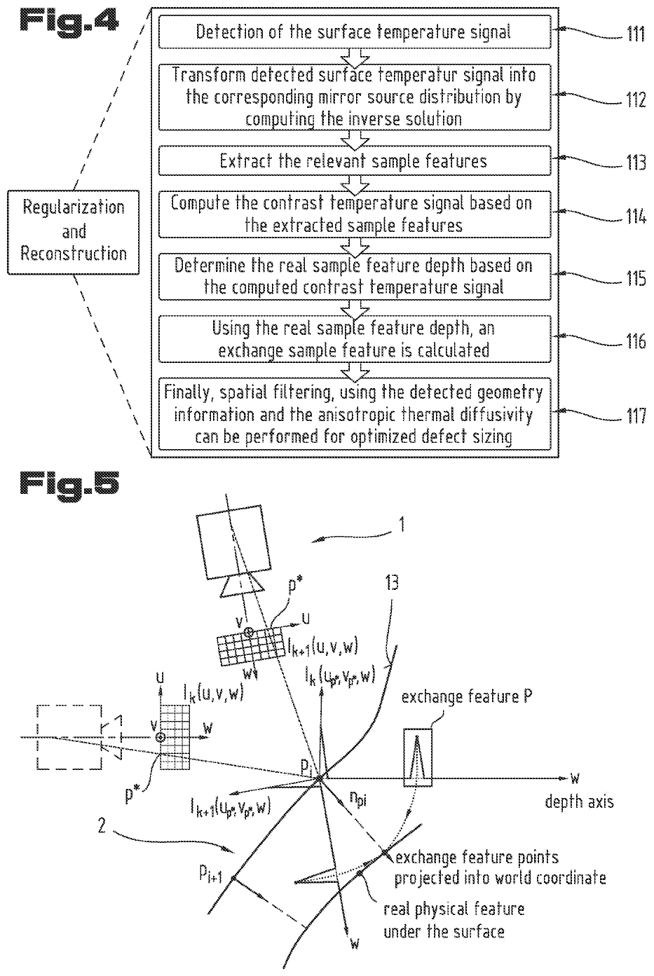

FIG. 4 shows a detail of FIG. 3 corresponding to the method step “regularization and reconstruction” in portion 103, further specified. Following the recording of the thermal response from the surface 13 of the test object 2 with the aid of the infrared detector array 4, a transformation into the mentioned mirror source representation takes place. In order to reconstruct defects 14 which lie on the surface 13 or below the surface 13 or to determine material parameters, the measured surface temperature signal Tₘₑₛₛ ϵIR\hat{ } (Nₜ×Nᵤ*Nᵥ) is transformed into the corresponding mirror source representation T_{Sq} ϵIR\hat{ } (N_{W}×Nᵤ*Nᵥ) (IR, set of real numbers). Nᵤ and Nᵥ describe the number of pixels of the area detector of the infrared detector array 4 in the u- and v-direction. The number of time steps for the measurement is represented by Nₜ and the number of coordinate points in the depth direction is represented by N_{w}. In the simplest case, the transformation matrix K ϵIR\hat{ } (Nₜ×N_{w}) can be represented by a Green's function with the thermal diffusivity α₃₃ in the following form.

$$G ( t , {w}^{′} ) = \frac{1}{\sqrt{4 {πα}_{33} t}} exp ( - \frac{{w}^{{′}^{2}}}{4 {α}_{33 t}} ) \qquad Equation ( 1 )$$

This function corresponds to the fundamental solution of the heat conduction equation. At this point, it should also be mentioned that other Green's functions can also be used due to existing component features and test environment features. With the thermal conductivity in the depth direction α₃₃ and with the discrete numerical steps t₁=1 Δₜ and tⱼ=j Δ_{z} and using the running variables 1={0, 1, 2, . . . , Nₜ−1} and j={0, 1, 2, . . . , N_{w}−1}, the elements of the transformation matrix K can be written as follows using the Green's function specified above:

$$K ( l , j ) = \frac{{ξΔ}_{w}}{\sqrt{4 {πα}_{33} {Δ}_{t} l}} exp ( - \frac{{ξ}^{2} {Δ}_{w}^{2} {j}^{2}}{4 {α}_{33} {Δ}_{t} l} ) = \frac{η}{\sqrt{π l}} exp ( - \frac{{η}^{2} {l}^{2}}{l} ) \qquad Equation ( 2 )$$

The term

$$η = \frac{{ξΔ}_{w}}{4 {α}_{33} {Δ}_{t}}$$

describes a dimensionless number, wherein ξ is a dimensionless scaling parameter for optimizing the quality of the inverse solution and Δt represents the temporal resolution of the surface temperature signal and Δw represents the depth resolution for the mirror source representation.

Possible temporal and local excitation patterns can be taken into account by a mathematical convolution of the transformation kernel or of the transformation matrix K with respect to time and location. Since the diffusion processes and therefore the heat conduction equation are considered at the macroscopic level, a linear matrix equation Tₘₑₛₛ=K T_{Sq} and therefore a linear inverse problem results in the discrete form. It can also be established that equation (2) has no dependence on the transverse coordinates u and v. Solving the matrix equation Tₘₑₛₛ=K T_{Sq} therefore is a local inverse problem. That is to say that the measured temperature signal can be transformed locally (pixel-by-pixel) into the corresponding mirror source representation.

A very poorly placed inverse problem has to be solved for the transformation on account of the entropy production during the heat diffusion. Different regularization methods can be used for this purpose. It should also be noted that the inverse problem can also be solved using machine learning approaches.

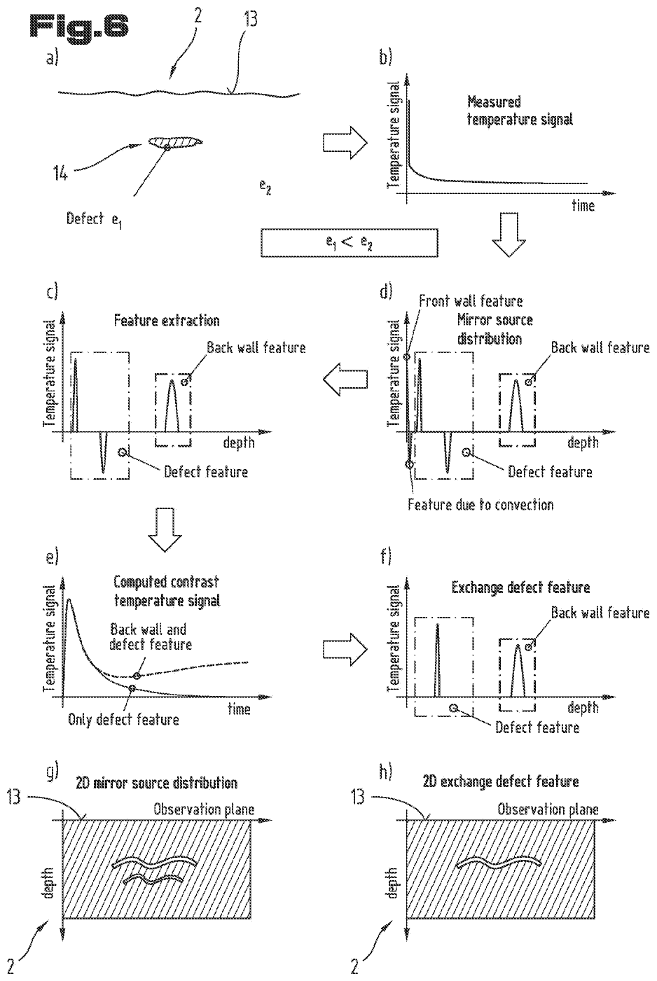

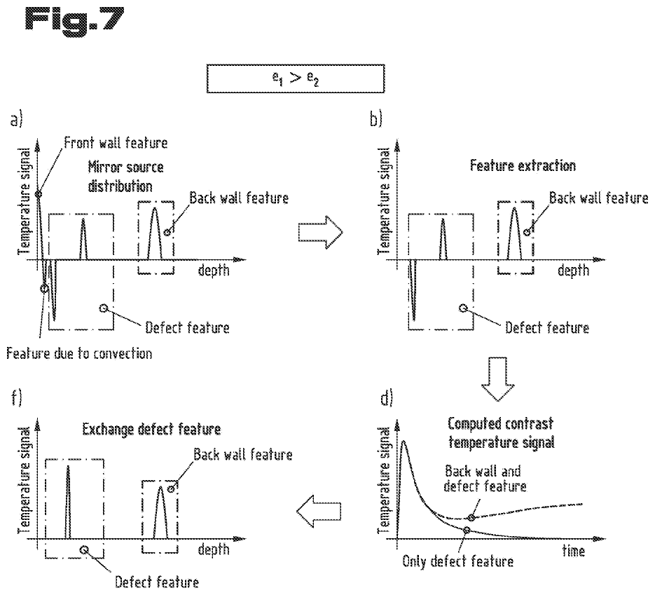

In the present case, the inverse problem is solved using additional information, such as, for example, positivity or sparcity (solution matrix is sparse) in the evaluation process. The calculated mirror source distribution as a function of the depth discloses the features of the measured surface temperature signal with respect to structurally identical boundary surfaces (surface 13) and defect boundary surfaces in the form of sources (positive amplitude) and sinks (negative amplitude). The sources and sinks can arise, for example, by defects or the prevailing boundary conditions, wherein features on account of defects can be clearly distinguished from features on account of the boundary conditions. The boundary conditions or test environment features can be described by the heat conduction, the heat radiation or the convection or a mixture of these effects. In addition, adiabatic boundary conditions only provide positive mirror source amplitudes. Heat radiation and convection can provide both negative and positive mirror source amplitudes (FIGS. 6, 7).

Based on the defect features, the depth position of the defect 14 can only be roughly estimated. In addition, the amplitudes do not provide any relevant information with respect to the defect 14 and the position of the rear wall on account of the boundary conditions and the observation surface. Therefore, the amplitudes are extracted on account of the defect 14 and the rear wall. A noise-free defect temperature signal is then calculated from the resulting signal. By eliminating the noise signal, the defect depth can now be determined more precisely by the evaluation of the maximum defect temperature signal.

A replacement mirror source signal I ϵIR\hat{ } (Nᵤ×Nᵥ×N_{w}) can then be determined from the calculated defect depth for each pixel of the infrared detector array 4 and each defect signal for a multidimensional defect representation (see FIGS. 6f and 6h).

Otherwise, if the thermal effusivity of the base material e₂ is larger than the thermal effusivity of the defect material e₁, the positive amplitude (source) before the negative amplitude (sink) can be seen on the depth scale of the mirror source distribution (FIGS. 6c, 6d). If e₁ is larger than e₂, first a sink and then a source result on the depth scale (FIG. 7).

The described transformation of the measured temperature signal into the corresponding mirror source representation does not take into account any transverse diffusion processes and geometry information of the possibly anisotropic and complexly shaped test object 2.

In a further evaluation step and with the aid of the geometry information of the test object 2 recorded by the surface scanner 8 in conjunction with known temperature conductivity tensor a, a local filtering can be carried out. A more precise reconstruction of the true interface dimensions is thereby possible. This local filtering can likewise be carried out by solving an inverse problem. This further and optional evaluation step is recommended specifically for defects 14 which lie deep below the surface 13 of the test object 2 and when the ratio of the thermal conductivities in the transverse direction and depth direction is large.

According to the illustration in FIG. 4, the surface temperature signals pass through a sequence of multiple steps for the evaluation thereof of the regularization and defect reconstruction. A first step 111 corresponds to the detection of the surface temperature signal Tₘₑₛₛ. In the subsequent step 112, the transformation of the measured surface temperature signal Tₘₑₛₛ into the corresponding mirror source distribution takes place according to the linear matrix equation Tₘₑₛₛ=K T_{Sq}. In a subsequent step 113, defect features are extracted. In step 114, a calculation of the defect temperature signal takes place based on the extracted defect features. The following step 115 corresponds to the determination of the real defect depth from the calculated defect temperature signal. The real defect depth is used in a subsequent step 116 to calculate a replacement mirror source signal. In a final step 117, a local filtering takes place based on the measured geometry information of the test object 2 and information about the known temperature conductivity tensor. Based on the results obtained, the size determination of the defect 14 in the test object 2 can be improved or optimized.

FIG. 5 shows the device 1 when carrying out the thermographic test of the test object 2.

With the aid of the excitation source 3, the test object 2 has already been thermally excited and the thermal response of the component over a predefined measuring period is detected by the infrared detector array 4 of the device 1 and also the geometry information is detected with the aid of the surface scanner 8 of the device 1 (FIGS. 1, 2). That is to say that a sequence of thermal images is recorded by the infrared detector array 4. Based thereon, a 3D depth signal Iₖ(u,v,w) is reconstructed from the at least one spatial position k of the device 1. According to the requirement, at least one image position (uₚ*, vₚ*) must be present for a surface point pᵢ and an associated, normalized normal vector n_{Pi}. Relevant substitute feature positions from the depth signal Iₖ(uₚ*,vₚ*,w) are projected into a global coordinate system for this purpose.

In the case of known material parameters (for example in the form of a temperature conductivity sensor) and in the case of normal vectors implicitly known from the surface 13 or manually defined, a relevant substitute feature P in the global coordinate system is composed of its position and its intensity.

$$P = [ \begin{matrix}x \\ y \\ z \\ I\end{matrix} ] = [ \begin{matrix}{p}_{i} + {n}_{pi} w Δ t α \\ {I}_{t} ( {u}_{p *} , {v}_{p *} , w )\end{matrix} ]$$

The projection of substitute feature positions of one or more data sets I(u,v,w) into the global coordinate system leads, according to FIG. 5, to an aggregation of substitute features on or close to the position of the physical component feature, provided that the substitute features belong to the same component feature (defect 14). This is the case, for example, in the case of adjacent surface points from a dimensioning or congruent or adjacent surface points from multiple measurements (that is to say a multiple performance of steps 101, 102 and 103 according to FIG. 3) from congruent or different spatial positions of the device 1. Such an aggregation of substitute features is also the case if surface points from multiple measurements (that is to say a multiple performance of steps 101, 102, 103 according to FIG. 3) from opposite spatial positions of the device 1, if the component to be tested or the test object 2 is sufficiently thin or the measurement of the temperature response is sufficiently long. In such a case, the opposite, non-visible component surface is visible as a substitute feature in each measurement.

The thermographic measurements to be superposed may differ from one another with respect to all customary measurement parameters, since these can be taken into account as preliminary information in the reconstruction and positioning of the substitute features. These measurement parameters can be: the temporal and local excitation form by the excitation source 3; the measuring frequency (corresponding to the recording of thermal images by the infrared detector array 4); the spatial resolution and the distance of the surface 13 of the test object 2 or the spatial position of the device 1.

When storing the transformed data in the form of a point cloud (that is to say the coordinates are explicitly present), the depth resolution can be defined independently of the resolution of the geometry detection by the surface scanner 8. In addition to the substitute feature position, the substitute feature intensity can also be assigned to a data point. This makes it possible to improve the visualization of the features of the test object 2, for example by texturing point clouds or rendered surfaces of the features or of the defect 14. Furthermore, this makes it possible to define intensity values if the result data are intended to be present in a three-dimensional Cartesian grid with implicit coordinates (volume pixels, “voxels” for short). The substitute feature positions of relevant data points are transferred into the grid by interpolation.

As a result of the systematic positioning of the substitute features in the global coordinate system, further reconstruction and segmentation methods can be used in a subsequent step, which reconstruction and segmentation methods make it possible to locate and visualize the component features more precisely. The introduction of geometric (surface points, normal directions, preliminary information about the features of the test object 2 such as orientation, size and shape) and material-specific additional information also makes it possible to use known methods based on superposition, triangulation, lateration, regression and machine learning.

The method for the thermographic reconstruction of the defect 14 is explained in more detail below with reference to FIGS. 6 and 7.

FIG. 6 illustrates the evaluation procedure for reconstructing a defect 14 and for determining material parameters of the test object 2. The illustration a) shows, by way of example, a defect-prone test object 2, wherein the thermal effusivity of the base material e₂ is larger than the thermal effusivity of the defect material e₁. Diagram b) shows a characteristic temperature signal for a measurement in the reflection mode in the defect region. The mirror source distribution calculated therefrom is illustrated in diagram d). Diagram c) shows the extracted defect and component features, diagram e) the defect temperature signal calculated therefrom and diagram f) the corrected depth distribution of the mirror sources. The illustrations g) and h) show a 2D visualization of the extracted defect and component features and the corrected depth distribution of the mirror sources.

The described method steps correspond to the measures already presented in FIG. 4. The expression of component features of the test object 2 depends on the thermal impedances of the base material and of the defect material, wherein the thermal impedances are formed by the respective effusivities, which in turn depend on the thermal conductivity k, the specific heat capacity cp and the material density p (FIG. 6a). The larger the difference in the thermal impedances, the more the characteristic component features of the test object 2 are displayed. Since the position of the image points in space with respect to one another is known, the individual feature intensities and positions can be used for a more precise feature localization and quantification by a suitable superposition. Component features below the surface 13 of the test object 2, which are represented, for example, by a defect boundary surface, can occur on account of their spatial extent in multiple image points lying next to one another, wherein a distortion of the spatial extent by the heat diffusion takes place at the same time. FIG. 6b shows, by way of example, a measured surface temperature signal as a function of time for the reflection (pulse-echo) configuration (excitation source 3 and infrared detector array 4 on the same side) based on a very short excitation pulse in the form of a Dirac-delta distribution with respect to time.

However, the described procedure for the thermographic defect reconstruction is applicable to all temporal and local thermal excitation functions, and also in the case of a transmission configuration (excitation source 3 and infrared detector array 4 on opposite sides).

In order to ensure that all relevant component features are detected, a test measurement can be carried out. The thermal diffusion time t_{d} and therefore the measuring time tₘₑₛₛ can be determined with a test measurement.

The temperature signal measured after thermal excitation has taken place can be transformed locally, that is to say pixel-by-pixel, into a corresponding mirror source representation. The diagram, illustrated in FIG. 6d, illustrates the calculated mirror source distribution as a function of depth and discloses the features of the measured surface temperature signal with respect to component boundary surfaces and defect boundary surfaces in the form of sources (recognizable by positive amplitudes) and sinks (recognizable by negative amplitudes). Finally, the diagram as illustrated in FIG. 6c is obtained by extraction of the amplitudes on account of the defect 14 and the rear wall.

A noise-free defect temperature signal is then calculated from the resulting signal. The defect depth can then be determined more precisely by the evaluation of the maximum defect temperature signal of the filtered defect temperature signal. This is explained by the illustrations in FIGS. 6e and 6g, wherein the diagram in FIG. 6g shows a cross-section through the surface 13 of the test object 2 with the corresponding mirror source distribution.

A replacement mirror source signal I ϵIR\hat{ } (Nᵤ×Nᵥ×N_{w}) can then be determined from the calculated defect depth for each camera pixel and defect signal for a multidimensional defect representation, as is illustrated by the illustrations in FIGS. 6f and 6h. In the example according to FIG. 6, according to the requirement, the thermal effusivity of the base material e₂ is larger than the thermal effusivity of the defect material e₁.

The evaluation procedure for reconstructing defects 14 and for determining material parameters is illustrated in FIG. 7. In contrast to the case dealt with by FIG. 6, the thermal effusivity of the base material e₂ is smaller than the thermal effusivity of the defect material e₁. The temperature signal was recorded in the reflection mode. The diagram a) shows the corresponding mirror source distribution in the defect region. Diagram b) shows the extracted defect and component features and diagram d) the defect temperature signal calculated therefrom. The corrected depth distribution of the mirror sources is shown in diagram c). FIG. 7 thus shows an example of the thermographic defect reconstruction for a case when the effusivity of the defect material e₁ is larger than the effusivity of the base material e₂. In this case, first a sink and then a source result on the depth scale (FIGS. 7a and 7b).

For a consistent registration of new thermographic data and the reconstruction of component features of the test object 2 from these data, the geometry features detected by the surface scanner 8 (for example by TOF camera, profile scanner, with reference to the device itself by the superposition of image data from different poses) and the position estimations from the inertial measuring unit are used. The position estimation of the sensor in the original coordinate system takes place continuously.

A preferred embodiment of the device 1 is that of a hand-held device on which all the required components are positioned at defined distances relative to one another.

In an alternative embodiment variant of the device 1, the spatial position relative to the component surface or the surface 13 of the test object 2 is provided by external data sources, for example by a single-axis or multi-axis robot which moves the device 1.

In a further alternative embodiment of the device 1, the surface 13 of the test object 2 and the inertial position of the device 1 relative to the surface 13 are provided by external data sources, for example by a CAD model of the test object 2. In a likewise alternative embodiment, the device 1 remains at rest and the test object 2 is moved by suitable devices. The relative position of the device 1 is determined by the manipulation unit of the test object 2 and provided to the device 1 for the evaluation.

A further application possibility or embodiment of the device for the thermal component test is described below referring again to the illustration of the device 1 according to FIG. 1. Here—prior to the already described method steps—an identification of the test object 2 is carried out at the beginning. That is to say that the control device 6 or the evaluation device 7 is configured to detect or to read in an automated manner an identifier 15 coded in any form, which is attached to the surface 13 of the test object 2. This makes it possible to later clearly assign the results of the thermographic component test carried out to the respective test object 2. Images which have preferably been made by the infrared camera or by the infrared detector array 4 of the identifier 15 serve as the basis for this. Alternatively, however, it is also possible to record the images required for the component identification with the aid of the optical camera 11. The control device 6 or the evaluation device 7 is configured for program-controlled decoding of the image information data and identification of the identifier 15. The identifier 15 can be formed in this embodiment variant of the device 1 by optoelectronically detectable writings or single-dimensional or multidimensional codes (such as a bar code or a QR code).

In a preferred embodiment of the device 1, a program-controlled user verification 16 is provided in the control device 6. In this embodiment variant of the device 1, it is therefore possible to limit the putting into operation thereof to a group of persons authorized for this purpose. Thus, for example, a user authentication can take place by checking a password input by the user via the operating terminal 10. Alternatively, a user authentication can also take place on the basis of technologies, such as a face recognition or an eye-iris recognition. For the recording of corresponding images, the infrared camera or the infrared detector array 4 or the optical camera 11 of the device 1 are alternatively available. The program-controlled user verification 16 of the device 1 could alternatively also take place on the basis of other technologies such as the reading out of an RFID element with corresponding readers or scanners and also the recognition of fingerprints. Corresponding to the respectively used technology, the user verification 16 of the device 1 is configured for image recognition or for decoding corresponding detection signals of a corresponding reader. A further exemplary embodiment of the user identification could, however, also provide a two-factor or multifactor authentication.

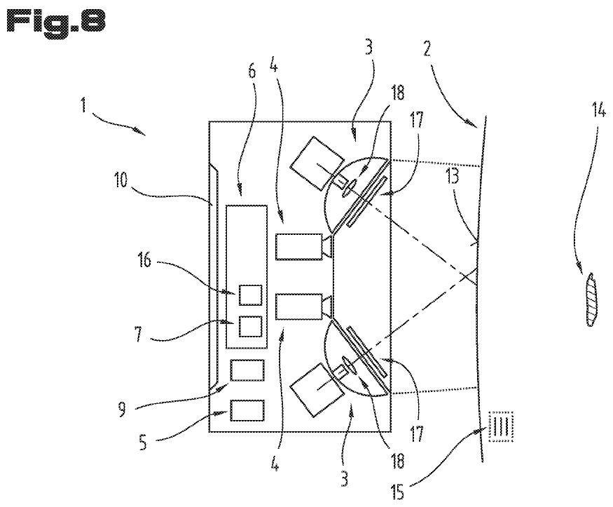

A further embodiment variant of a device 1 for the thermographic component test is described below with reference to FIG. 8. FIG. 8 shows a device 1 for the non-destructive component test of a test object 2, which likewise comprises two excitation sources 3 for generating a heat flow in the test object 2 and a control device 6 with an evaluation device 7. In this example of the device 1, two infrared detector arrays 4 are provided for detecting or capturing the heat radiation emitted from the surface 13 of the test object 2. This allows a combined evaluation of the surface temperature signals obtained from the respective infrared images of the two infrared detector arrays 4, as a result of which a greater local or temporal resolution can be achieved in the following.

On the other hand, an improvement in the quality of the results of the component test determined with the method can also be achieved by the type of thermal excitation of the surface 13 of the test object 2 caused by the excitation sources 3. One possibility for this is to provide a filter 17 in the respective beam path of the two excitation sources 3. A narrower spectral range is selected from the infrared radiation generated by the two excitation sources 3 by the two filters 17.

Another embodiment variant provides that respectively one focusing device and/or one focusing lens 18 is provided in the beam path of the respective excitation source 3. The focusing lenses 18 allow the method for the component test to be carried out in such a manner that the thermal excitation can be carried out with the infrared radiation on the surface 13 of the test object 2 in a locally concentrated manner. By a corresponding configuration or setting of the focusing lenses 18, for example, the heat input can be concentrated onto a surface region which is as point-like or line-like or path-like as possible. This is advantageous for the evaluation method to be applied insofar as the initial conditions of the heat flow generated in the test object 2 can be determined or predefined more precisely.

The exemplary embodiments show possible embodiment variants, wherein it should be noted at this point that the disclosure is not restricted to the specifically illustrated embodiment variants thereof, but rather diverse combinations of the individual embodiment variants with one another are also possible and this variation possibility lies within the knowledge of the person skilled in the art working in this technical field on account of the teaching on the technical action by the disclosure in question.

The scope of protection is determined by the claims. However, the description and the drawings are to be used for the interpretation of the claims. Individual features or feature combinations from the different exemplary embodiments shown and described can represent independent inventive solutions per se. The object on which the independent inventive solutions are based can be taken from the description.

All specifications on value ranges in the description in question are to be understood such that these encompass any desired and all partial ranges therefrom, e.g. the specification 1 to 10 is to be understood such that all partial ranges, starting from the lower limit 1 and the upper limit 10, are also encompassed, i.e. all partial ranges begin with a lower limit of 1 or greater and end at an upper limit of 10 or less, e.g. 1 to 1.7, or 3.2 to 8.1, or 5.5 to 10.

For the sake of order, it should finally be pointed out that, for a better understanding of the construction, elements have in part been illustrated not to scale and/or enlarged and/or reduced in size.

### LIST OF REFERENCE SIGNS

1 Device
2 Test Object
3 Excitation Source
4 Infrared detector array
5 Supply unit
6 Control device
7 Evaluation device
8 Surface scanner
9 Inertial measuring unit
10 Operating terminal
11 Camera
12 Optical axis
13 Surface
14 Defect
15 Identifier
16 User verification
17 Filtering
18 Focusing lens
100 measure
101 portion
102 portion
103 portion
111 step
112 step
113 step
114 step
115 step
116 step
117 step

1.-28. (canceled)

29. A device for a thermographic component test,
comprising an excitation source for generating an unsteady heat flow in a test object,
an infrared detector array for detecting heat radiation emitted from a surface of the test object,
a surface scanner,
a control device and an evaluation device, characterized in that the device comprises an inertial measuring unit for detecting movements of the device.

30. The device according to claim 29, characterized in that a geometry detection system is configured to calculate spatial coordinates of the surface of the test object.

31. The device according to claim 30, characterized in that the geometry detection system is configured to calculate a relative spatial position between the device and the test object.

32. The device according to claim 29, characterized in that the infrared detector array of the surface scanner and the inertial measuring unit are arranged relative to one another at defined distances and defined orientations in the device.

33. The device according to claim 29, characterized in that two infrared detector arrays are configured to detect the heat radiation emitted from a surface of the test object.

34. The device according to claim 29, characterized in that two excitation sources are formed.

35. The device according to claim 29, characterized in that the excitation source comprises a filter for selecting a part of a spectral range of the infrared radiation.

36. The device according to claim 29, characterized in that the excitation source comprises a focusing lens.

37. The device according to claim 29, characterized in that at least one of the control device and the evaluation device is configured for program-controlled identification of the test object by decoding an identifier attached to the surface of the test object.

38. The device according to claim 29, characterized in that a user verification is encompassed and the user verification is configured for program-controlled authentication of a user, wherein a method is used for authentication of the user, which is selected from a group comprising inputting a password, performing a face recognition or an eye-iris recognition, detecting a fingerprint, reading out an RFID element, or reading out a user card provided with a magnetic strip.

39. The device according to claim 29, characterized in that the evaluation device is configured for program-controlled reconstruction of a defect in a test object, wherein a surface temperature signal Tₘₑₛₛ is calculated by the evaluation device from data of infrared images of the infrared detector array, and wherein the surface temperature signal Tₘₑₛₛ is transformed into a mirror source representation T_{sq} using a regularization method.

40. A method for thermographic component test of a test object with a device comprising an excitation source, an infrared detector array, a surface scanner, a control device and an evaluation device, comprising the following method steps:
detecting a spatial position and orientation of the device relative to the test object and detecting a surface of the test object with the surface scanner;
generating an unsteady heat flow in the test object by the excitation source;
recording infrared images of the surface of the test object with the infrared detector array during a preselected measuring period;
reconstructing a spatial position of a defect from detected data of the infrared images by the evaluation device,
characterized in that a surface temperature signal Tₘₑₛₛ is calculated by the evaluation device from the data of the infrared images for reconstructing the defect,
and in that the surface temperature signal Tₘₑₛₛ is transformed into a mirror source representation T_{sq}, wherein Tₘₑₛₛ=K T_{Sq}, and wherein K is a transformation matrix.

41. The method according to claim 40, characterized in that at least one of substitute mirror sources and substitute features are calculated from the mirror source representation T_{Sq}.

42. The method according to claim 41, characterized in that a regularization method or a machine learning approach is used to calculate at least one of the substitute mirror sources and substitute features.

43. The method according to claim 42, characterized in that Green's functions based on the heat conduction equation are used in the regularization method.

44. The method according to claim 40, characterized in that additional information from a group comprising a dimensionality of the heat flow, a number of boundary layers in the test object, a position of boundary layers in the test object, thermophysical material properties or boundary conditions is used in reconstructing the spatial position of the defect.

45. The method according to claim 40, characterized in that an inertial measuring unit is arranged in the device, wherein the infrared detector array of the surface scanner and the inertial measuring unit are arranged relative to one another at defined distances and defined orientations in the device.

46. The method according to claim 40, characterized in that the spatial position and the orientation of the device and the test object relative to one another are measured by the inertial measuring unit.

47. The method according to claim 40, characterized in that external data sources are taken into account for detecting the spatial position and orientation of the device and for detecting the surface of the test object.

48. The method according to claim 40, comprising at least one of the following features:
characterized in that in the method step of recording the infrared images of the surface of the test object, the infrared images are recorded by two infrared detector array cameras;
characterized in that in the method step of generating a heat flow in the test object by the excitation source, from infrared radiation emitted by the excitation source, a reduced spectral range of the infrared radiation is selected by a filter;
characterized in that in the method step of generating a heat flow in the test object by the excitation source, infrared radiation emitted by the excitation source acts on the surface of the test object by at least one of a focusing device and a focusing lens in a manner concentrated as at least one of point-like and line-like or path-like as possible;
characterized in that additional information about the component geometry and the material properties of the test object is used for optimized discretization of the reconstruction space;
characterized in that the method steps are repeated one or more times, carried out from a different spatial position and orientation of the device relative to the test object, and results of reconstructions of the spatial position of the defect are superpositioned;
characterized in that temperature- and location-calibrated image data are calculated from the infrared images;
characterized in that the extracted features of the defects or boundary layers are used for data compression;
characterized in that prior to the method step of detecting the spatial position and orientation of the device relative to the test object, a component identification is carried out by detecting an identifier attached to the test object;
characterized in that prior to the method step of detecting the spatial position and orientation of the device relative to the test object, a user authentication is carried out, wherein the user authentication comprises a method which is selected from a group comprising inputting a password, performing a face recognition or an eye-iris recognition, detecting a fingerprint, reading out an RFID element, or reading out a user card provided with a magnetic strip.
